(19) United States
(12) Patent Application Publication
(10) Pub. No.: US 2025/0332826 A1
(43) Pub. Date: Oct. 30, 2025

(54) Calendering Unit and Method for Adapting the Reflective Properties of a Printed Recording Medium

(71) Applicant: Canon Production Printing Holding B.V., Venlo (NL)

(72) Inventor: David Croll, Unterhaching (DE)

(21) Appl. No.: 19/191,313

(22) Filed: Apr. 28, 2025

(30) Foreign Application Priority Data
Apr. 29, 2024 (DE) 10 2024 111 950.0

(51) Int. Cl. B41F 25/00; B41F 33/00; B41M 7/00; G01N 21/57

(52) U.S. Cl. CPC B41F 25/00; B41F 33/0009; B41F 33/0036; B41M 7/00; G01N 21/57

(57) ABSTRACT

A calendering unit for a printing device is described that efficiently and gently matches the gloss of the printed and unprinted partial regions of the recording medium by calendering a recording medium printed to by the printing device.

### CROSS-REFERENCE TO RELATED APPLICATION

This application claims priority to German Patent Application No. 10 2024 111 950.0 filed Apr. 29, 2024, the disclosure of which is hereby incorporated by reference in its entirety.

### BACKGROUND OF THE INVENTION

### Field of the Invention

The invention relates to a calendering unit and a corresponding method that are intended to adapt, in particular to homogenize, the reflective properties, in particular the gloss, of a printed recording medium.

### Description of Related Art

Printing devices, in particular inkjet printing devices, can be used for printing to recording media such as, for example, paper. For example, for this purpose one or more nozzles are used in order to fire ink droplets onto the recording medium, and thus to generate a desired print image on the recording medium.

A printed recording medium typically has a printed partial region and a non-printed or unprinted partial region, wherein the partial regions typically have different optical reflective properties, in particular a respective different gloss. To match the gloss, the printed recording medium can be provided with a plastic coating, whereby the complexity and the costs of the printing process are increased, however. A later recycling of the printed recording medium, in particular the implementation of a print color removal process, is also made more difficult by such a coating.

### SUMMARY OF THE INVENTION

The present document deals with the technical object of effecting a particularly efficient and gentle matching of the reflective properties of a printed recording medium. The object is respectively achieved by the features described hereinafter.

According to one aspect, a method is described for approximating, in particular for equalizing, at least one reflective property, in particular the gloss, of different partial regions of a printed recording medium. The method comprises providing a printed recording medium that has an unprinted first partial region and a printed second partial region on a first side. Furthermore, the method comprises the calendering of the printed recording medium in order to reduce the difference value between the first value of the reflective property in the first partial region and the second value of the reflective property in the second partial region.

According to a further aspect, a calendering unit for a printing device is described, wherein the printing device is configured to print a print image onto a recording medium so that the printed recording medium has a first side with an unprinted first partial region and a printed second partial region. The calendering unit comprises at least one calendering module that is designed to calender the printed recording medium in order to reduce the difference value between the first value of the reflective property in the first partial region and the second value of the reflective property in the second partial region.

The use of a calendering module and/or the use of a calendering process is thus described in order to approximate and/or match to one another the reflective properties of an unprinted partial region and a printed partial region of a recording medium, in particular of a paper.

### BRIEF DESCRIPTION OF THE DRAWINGS

In the following, examples are described in detail using the schematic drawings. Shown therein are:

FIG. 1 a block diagram of an example of an inkjet printing device with a calendering unit;

FIG. 2 an example of a calendering unit with a plurality of calendering modules;

FIG. 3a an example of a printed side of a recording medium;

FIG. 3b an example of a modification of the reflective properties of the printed partial region and unprinted partial region of a recording medium due to a sequence of calendering steps; and

FIG. 4 a workflow diagram of an example of a method for matching the reflective properties of the printed partial region and unprinted partial region of a recording medium.

The non-limiting embodiments of the present invention will be described with reference to the accompanying drawings. Elements, features and components that are identical, functionally identical and have the same effect are, insofar as is not stated otherwise, respectively provided with the same reference character.

### DESCRIPTION OF THE INVENTION

In the following description, numerous specific details are set forth in order to provide a thorough understanding of the embodiments of the present invention. However, it will be apparent to those skilled in the art that the embodiments, including structures, systems, and methods, may be practiced without these specific details. Well-known methods, procedures, components, and circuitry have not been described in detail to avoid unnecessarily obscuring embodiments of the invention. The connections shown in the figures between functional units or other elements can also be implemented as indirect connections, wherein a connection can be wireless or wired. Functional units can be implemented as hardware, software or a combination of hardware and software.

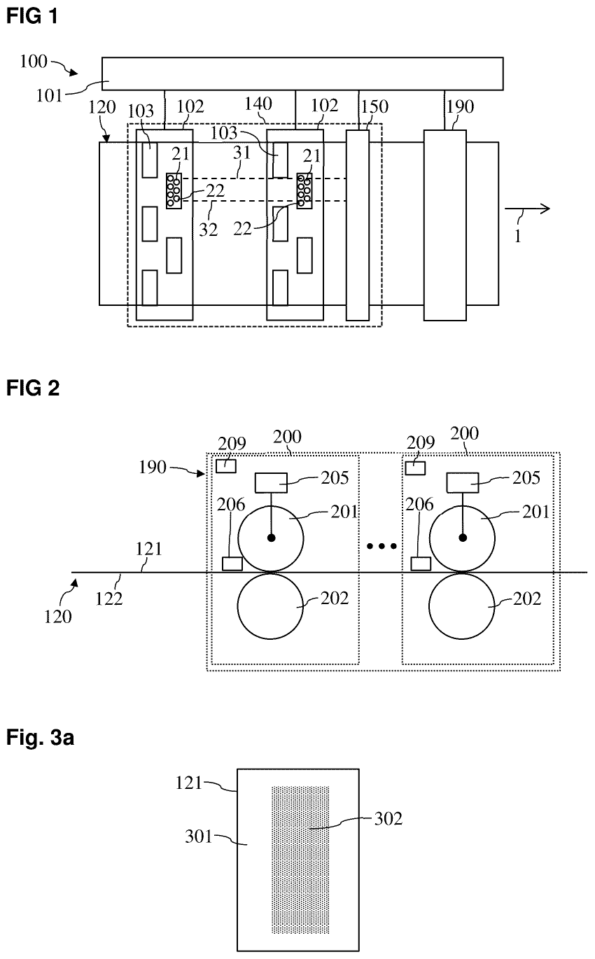

The printing device 100 depicted in FIG. 1 is designed for printing to a recording medium 120 in the form of a sheet or page or plate or belt or web. The recording medium 120 can be produced from paper, paperboard, cardboard, metal, plastic, textiles, a combination thereof, and/or other materials that are suitable and can be printed to. The recording medium 120 is guided or conveyed through the print group 140 of the printing device 100 along the transport direction 1, represented by an arrow. A recording medium 120 in the form of a web can be taken off of a roll at the input of the printing device 100. If applicable, the recording medium 120 can be take up on a roll again at the exit of the printing device 100. Alternatively, at the exit of the printing device 100, the recording medium 120 can be cut into individual sheets and stored.

In the depicted example, the print group 140 of the printing device 100 comprises two print bars 102, wherein each print bar 102 can be used for printing with ink of a defined color, for example black, cyan, magenta, and/or yellow, and MICR ink if applicable. Different print bars 102 can be used for printing with respective different inks. Furthermore, the printing device 100 comprises at least one drying unit 150 that is configured to dry, and therewith fix, a print image printed onto the recording medium 120.

A print bar 102 can comprise one or more print heads 103, that are possibly arranged side by side in a plurality of rows in order to print the dots of different columns 31, 32 of a print image onto the recording medium 120. In the example presented in FIG. 1a, a print bar 102 comprises five print heads 103, wherein each print head 103 prints the dots of a group of columns 31, 32 of a print image onto the recording medium 120.

In the embodiment depicted in FIG. 1, each print head 103 of the print group 140 comprises a plurality of nozzles 21, 22, wherein each nozzle 21, 22 is configured to fire ink droplets onto the recording medium 120. For example, a print head 103 of the print group 140 can comprise multiple thousands of effectively utilized nozzles 21, 22 that are arranged along multiple rows transverse to the transport direction 1 of the recording medium 120, i.e. along the print width. Dots of a line of a print image can be printed onto the recording medium 120 transverse to the transport direction 1, i.e. along the width of the recording medium 120, by means of the nozzles 21, 22 of a print head 103 of the print group 140.

The printing device 100 also comprises a control unit 101, for example a driving hardware and/or a controller, that is configured to drive the actuators of the individual nozzles 21, 22 of the individual print heads 103 of the print group 140 in order to apply the print image onto the recording medium 120 depending on print data. The print data can respectively indicate for each nozzle 21, 22 (i.e. for each column 31, 32 of the print image), and for each line of the print image, whether an ink ejection should take place or not, and possibly what quantity of ink should be ejected. In an exemplary embodiment, the control unit 101 includes processing circuitry or at least one processor that is configured to perform one or more functions and/or operations of the control unit 101, including activating the actuators of the individual nozzles 21, 22 of the individual print heads 103 of the print group 140 to apply the print image onto the recording medium 120 based on print data, processing print and/or other data, control one or more modes of the printing device 100 and/or controlling one or more operations of the printing device 100. In an exemplary embodiment, the control unit 101 includes one or more interfaces (e.g. a wired and/or wireless input and/or output interface, transceiver, or the like) that are configured to receive or output data or information. For example, the control or processing unit 101 may receive signals generated by one or more components of the printing device 100 (e.g. from a user interface of the printing device 100) and/or output control signals to one or more components of the printing device 100. In an exemplary embodiment, the control unit 101 includes a memory configured to store data/information, and/or store executable code that is executable by the processing circuitry to cause the processing circuitry or at least one processor to perform the operation(s) of the control unit 101.

The unprinted recording medium 120 can possibly have a glossy surface. The printing to such a recording medium 120 typically leads to the printed partial region of the recording medium 120 having a gloss that is reduced relative to the gloss of the unprinted partial region of the recording medium 120. Such an inhomogeneity of the gloss is typically unwanted, and if applicable a plastic coating can be applied to the printed recording medium 120 in order to produce a uniform gloss of the printed recording medium 120. This coating step is linked with additional costs and typically increases a later recycling expense of the printed recording medium 120, in particular in the removal of print color.

The printing device 100 depicted in FIG. 1 comprises a calendering unit 190 that is designed to approximate, in particular to match, the gloss-generally one or more reflective properties-of the different partial regions of a printed recording medium 120. Further details of an exemplary calendering unit 190 are depicted in FIG. 2. The calendering unit 190 can have one or more calendering modules 200. A calendering module 200 comprises a first roller 201 that acts on the first, printed side 121 of the printed recording medium 120, and a second roller 202 that acts on the opposite second, possibly unprinted side 122 of the printed recording medium 120. The two rollers 201, 202 form a roller or calender nip through which the printed recording medium 120 is guided.

A calendering module 200 comprises a settings module 205 that is configured to set one or more process parameters of the calendering module 200. Examples of process parameters are
the surface temperature of the first and/or second roller 201, 202;
the physical pressure in the roller nip or calender nip between the two rollers 201, 202; and/or
the rotational speed of the first and/or the second rollers 201, 202.

The control unit 209 of the calendering module 200, which is part of the control unit 101 of the printing device 100, for example, can be configured to set one or more process parameters of the calendering module 200, in particular in order to effect an equalization of the values of one or more reflective properties of the different partial regions of the printed recording medium 120. The one or more process parameters of the calendering module 200 can be set depending on printing information with regard to the printed recording medium 120. Examples of printing information comprise
the type of ink that was printed onto the recording medium 120; and/or
the quantity of ink that was printed onto the recording medium 120.

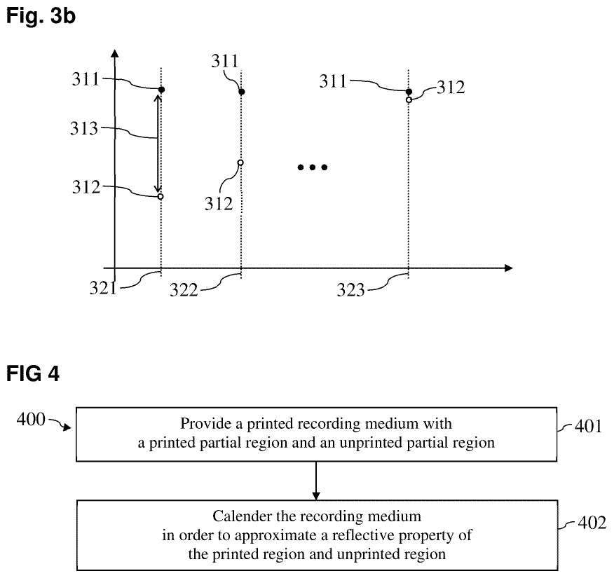

Alternatively or additionally, the one or more process parameters of the calendering module 200 can be set depending on sensor data with regard to the one or more reflective properties of the printed recording medium 120. The sensor data can be acquired by a sensor module 206 of the calendering module 200. The sensor module 206 can, for example, comprise a reflectometer and/or a gloss meter and/or a camera. The sensor module 206 can be configured to acquire sensor data with regard to the value of a reflective property, for example the gloss, for a plurality of different locations on the first side 121 of the printed recording medium 120. FIG. 3a shows an example of a first page 121 of the printed recording medium 120 with a first, unprinted partial region 301 and a second, printed partial region 302.

As is shown by way of example in FIG. 3b, a first value 311 of the reflective property for the first partial region 301 and a second value 312 of the reflective property for the second partial region 302 can be determined on the basis of the sensor data of the sensor module 206. The first value 311 and the second value 312 can have a relatively large difference value 313, such that the first partial region 301 and the second partial region 302 have significantly different reflective properties, which can be unwanted. The control unit 209 of the calendering module 200 can be configured to set the one or more process parameters of the calendering module 200 depending on the first value 311, the second value 312, and/or the difference value 313 of the reflective property. For example, the higher the difference value 313, the higher that the temperature of the first roller 201 and/or the physical pressure in the roller or calender nip can be set. By taking into account sensor data with regard to the values 311, 312 of the reflective property of different partial regions 301, 302 of the printed recording medium 120 in the determination of one or more process parameters of the calendering module 200, an especially precise and reliable matching of the values 311, 312 of the reflective property in the different partial regions 301, 302 of the printed recording medium 120 can be effected.

The calendering unit 190 can have a plurality of calendering modules 200 that follow one another in order to incrementally effect a matching of the values 311, 312 of the reflective property in the different partial regions 301, 302 of the printed recording medium 120. This is depicted by way of example in FIG. 3b, in which are shown the values 311, 312 of the reflective property for three successive calendering instances 321, 322, 323, i.e. for three successive calendering modules 200. How the values 311, 312 of the reflective property can be increasingly matched is clear from FIG. 3b.

A calendering or calender method is thus used in order to set the degree of gloss of the surface of a printed recording medium 120. An essentially homogeneous gloss can thereby be produced for a printed partial region 302 and an unprinted partial region 301 of the surface. Upon calendering, the printed recording medium 120 is guided through one or more gaps between two respective rollers 201, 202. A belt can be used as an alternative to a roller 201, 202. In a calendering module 200, a respective belt can thus be used instead of the first and/or the second roller 201, 202. A roller and/or a belt can be comprised of metal, rubber, or a different polymer. Metal (in particular a metal roller 201) is thereby preferably used for the first side 121 of the recording medium 120. On the other hand, a rubber-coated or polymer-coated roller 202 or belt can be used a counter-roller or counter-belt for the second side 122 of the recording medium 120. A pressure is exerted in the gap or, respectively, nip, whereby the gloss of the printed partial region 302 is altered. The recording medium 120 can be heated directly before the calendering and/or by heating the rollers or belts. Alternatively or additionally, one or more calendering aids can be applied onto the recording medium 120 and/or onto the calendering rollers or calendering belts 201 and 202 directly before the calendering process. Examples of calendering aids are water, a water/polyol mixture, and/or (water) vapor.

In particular given a glossy paper as a recording medium 120, a calendering module 200 can thus be used in which the printed side 121 of the paper comes into contact with a hard, smooth metal roller 201 that, for example, is heated to 70° C. The pressure in the nip can be 90 N/m, for example. The velocity of the recording medium 120 can be 10 m/min, for example. A metal roller 202 coated with polymer is preferably used on the back side 122 of the paper. The degree of gloss can be adjusted via adaptation of one or more process parameters for the calendering. Examples of process parameters are: the roller diameter, the heating temperature, the gap pressure, the hardness of the polymer coating on a roller, the number of gaps in the calendering unit 190, the calendering speed etc.

Given use of a matte and/or satinized recording medium 120, it can be advantageous to use a structured calendering roller 201 that, for example, has a metal surface. The degree of gloss in the printed and unprinted partial regions 301, 302 can be set by the structure of the roller surface in combination with the selection of the one or more process parameters.

A cost-efficient adaptation of one or more reflective properties of a printed recording medium 120 can thus be effected without using additional material (possibly apart from a calendering aid). In particular, a coating of the printed recording medium 120 can be omitted. The process described in this document also enables the use of pigment-based ink, instead of dye-based ink, in the print group 140 of the printing device 100, whereby the quality of the produced print product can be further increased, in particular with respect to light-fastness. The recycling capability of the printing product can thus also be improved.

FIG. 4 shows a workflow diagram of an example of a method 400 for approximating, in particular matching, at least one reflective property, in particular the gloss, of different partial regions 301, 302 of a printed recording medium 120. The method 400 can be executed by the calendering unit 190 of a printing device 100.

The method 400 comprises providing 401 a printed recording medium 120 that has on the first side 121 an unprinted, first partial region 301 and a printed, second partial region 302. The printed recording medium 120 can be provided at the output of the print group 140 of the printing device 100. The recording medium 120 can have been printed to with pigment-based ink.

The method 400 also comprises the calendering 402 of the printed recording medium 120. The calendering 402 can be effected in order to reduce the difference value 313 between the first value 311 of the reflective property in the first partial region 301 and the second value 312 of the reflective property in the second partial region 302. In particular, the calendering 402 can be effected such that the difference value 313 between the first value 311 of the reflective property in the first partial region 301 and the second value 312 of the reflective property in the second partial region 302 is reduced.

For this purpose, one or more process parameters for the calendering 402 of the printed recording medium 120 can be set. The one or more process parameters can, if applicable, be set individually for each calendering module 200. The one or more process parameters can comprise
the temperature of the recording medium 120 upon calendering 402 the printed recording medium 120;
the temperature of at least one calendering module 200, in particular of the rotating elements 201, 202 of the calendering module 200, of the calendering unit 190 that is used to calender 402 the printed recording medium 120;
the physical pressure that is effected on the recording medium 120 upon calendering 402 said printed recording medium 120, in particular in the gap between two rotating elements 201, 202 (for example rollers or belts);
the type and/or the quantity of the calendering aid that is used in calendering 402 the printed recording medium 120; and/or
the number of successive calendering modules 200 that are used to calender 402 the printed recording medium 120.

By calendering a printed recording medium 120, the reflective property, in particular the gloss, of the printed recording medium 120 can be especially efficiently and gently homogenized.

Sensor data with regard to the first value 311, the second value 312, and/or the difference value 313 of the reflective property can be acquired within the scope of the method 400. The sensor data can be acquired by a sensor unit 206, in particular by a gloss meter. The one or more process parameters for the calendering 402 of the printed recording medium 120 can then be set depending on the sensor data. The reflective property, in particular the gloss, of the printed recording medium 120 can thus be homogenized especially reliably and precisely.

The setting of the one or more process parameters can take place within the scope of a regulation. For this purpose, sensor data can be repeatedly acquired with regard to the first value 311, the second value 312, and/or the difference value 313 of the reflective property for the already-calendered printed recording medium 120. The adapted one or more process parameters can then be used for the calendering 302 [sic] of the subsequently printed recording medium 120. The result of the calendering step can then in turn by checked using the acquired sensor data, and a new adaptation of the one or more process parameters can be effected. An especially robust and precise homogenization of the reflective property of printed recording media 120 can thus be effected within the scope of a repeated adaptation of one or more process parameters on the basis of repeatedly acquired sensor data. This can in particular takes place given the processing of a recording medium 120 in the form of a belt.

A control loop can thus be provided that uses the one or more process parameters as a controlled variable. The difference value 313 of the reflective property can be used as a controlled variable, wherein the controlled variable should be set to a defined target value, for example a target value of zero.

The method 400 can comprise the determination of print information with regard to the print image printed onto the second partial region 302 of the recording medium 120. The print information can specify
the type of ink that was applied to print the print image onto the second partial region 302 of the recording medium 120; and/or
the quantity of ink that was applied to print the print image onto the second partial region 302 of the recording medium 120.

The one or more process parameters for the calendering 402 of the printed recording medium 120 can then be set depending on the print information. The reflective property, in particular the gloss, of the printed recording medium 120 can be particularly reliably and precisely homogenized by taking into account the printing information with regard to the printed second partial region 302 of the recording medium 120.

Furthermore, a calendering unit 190 for a printing device 100 is described in this document. As has already been presented, the printing device 100 is configured to print a print image onto a recording medium 120 so that the printed recording medium 120 has a first side 121 with an unprinted first partial region 301 and with a printed second partial region 302.

The calendering unit 190 comprises at least one calendering module 200 that is designed to calender the printed recording medium 120. The calendering of the printed recording medium 120 enables the difference value 313 between the first value 311 of the reflective property in the first partial region 301 and the second value 312 of the reflective property in the second partial region 302 to be reduced.

A calendering unit 190 for a printing device 100 is thus described that, via calendering of a recording medium 120 printed to by the printing device 100, efficiently and gently approximates, in particular matches, the gloss of the printed and unprinted partial regions 301, 302 of the recording medium 120.

The calendering module 200 typically comprises a first rotating element 201, in particular a first roller, and a second rotating element 202, in particular a second roller, that form a gap through which the printed recording medium 120 is guided so that the first side 121 of the printed recording medium 120 contacts the first rotating element 201. The first rotating element 201 preferably has a metal surface. Alternatively or additionally, the second rotating element 202 can have a polymer-based and/or rubber-based surface. Within the calendering unit 190, the printed recording medium 120 can thus be guided through at least one calendering gap or calendering nip.

The calendering unit 190 can have a plurality of successive calendering modules 200 that are respectively configured to calender the printed recording medium 120 in order to incrementally reduce the difference value 313 between the first value 311 of the reflective property in the first partial region 301 and the second value 312 of the reflective property in the second partial region 302. An especially precise homogenization of the reflective property of the printed recording medium 120 can be effected by using a plurality of calendering modules 200 and/or a plurality of calendering steps.

The calendering unit 190, in particular the calendering module 200, can comprise a sensor module 206 that is configured to acquire sensor data with regard to the first value 311, the second value 312, and/or the difference value 313 of the reflective property, before and/or after the printed recording medium 120 has traveled through the calendering module 200. Furthermore, the calendering unit 190, in particular the calendering module 200, can comprise a control unit 101 that is configured to set one or more process parameters of the calendering unit 190, in particular of the calendering module 200, depending on the sensor data.

Furthermore, a printing device 100 is described that comprises a print group 140 that is configured to print a print image onto a recording medium 120 so that the printed recording medium 120 has a first side 121 with an unprinted first partial region 301 and with a printed second partial region 302. The printing device 100 also comprises the calendering unit 190 described in this document. The calendering unit 190 can be configured to reduce the difference value 313 between the first value 311 of the reflective property in the first partial region 301 and the second value 312 of the reflective property in the second partial region 302.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

For the purposes of this discussion, the terms “processing circuitry” and “control unit” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

1 transport direction
21, 22 nozzle (print image)
31, 32 column (of the print image)
100 printing device
101 control unit
102 print bar
103 print head
120 recording medium
121 printed first side
121 second side
140 print group
150 drying unit
190 calendering unit
200 calendering module
201 first rotating element (first roller)
202 second rotating element (second roller)
205 settings module
206 sensor module
209 control unit (calendering module)
301 unprinted (first) partial region
302 printed (second) partial region
311 first value of the reflective property
312 second value of the reflective property
313 difference value of the reflective property
321-323 calendering instance
400 method for adapting the reflective properties of different partial regions of a printed recording medium
401-402 method steps

1. A method for approximating at least one reflective property of different partial regions of a printed recording medium, the method comprising:
providing a printed recording medium that has on a first side an unprinted, first partial region and a printed, second partial region; and
calendering of the printed recording medium in order to reduce a difference value between a first value of the reflective property in the first partial region and a second value of the reflective property in the second partial region.

2. The method according to claim 1, further comprising:
a setting of one or more process parameters for the calendering of the printed recording medium, wherein
the one or more process parameters comprise:
a temperature of the recording medium upon calendering the printed recording medium;
a temperature of at least one calendering module that is used to calender the printed recording medium;
a physical pressure that is effected on the recording medium upon calendering the printed recording medium;
a type and/or a quantity of a calendering aid that is used in calendering the printed recording medium; and/or
a number of successive calendering modules that are used to calender the printed recording medium.

3. The method according to claim 1, further comprising:
determining sensor data with regard to the first value, the second value, and/or the difference value of the reflective property; and
setting one or more process parameters for the calendering of the printed recording medium depending on sensor data.

4. The method according to claim 1, further comprising:
determining print information with regard to a print image printed onto the second partial region of the recording medium; wherein the print information specifies
a type of ink that was applied to print the print image onto the second partial region of the recording medium; and/or
a quantity of ink that was applied to print the print image onto the second partial region of the recording medium; and
setting one or more process parameters for the calendering of the printed recording medium depending on the print information.

5. A calendering unit for a printing device, the printing device configured to print a print image onto a recording medium so that the printed recording medium has a first side with an unprinted first partial region and a printed second partial region, the calendering unit comprising:
at least one calendering module configured to calender the printed recording medium in order to reduce a difference value between a first value of the reflective property in the first partial region and a second value of the reflective property in the second partial region.

6. The calendering unit according to claim 5, wherein the calendering module comprises a sensor module that is configured to acquire sensor data with regard to the first value, the second value, and/or the difference value of the reflective property, before and/or after the printed recording medium has traveled through the calendering module.

7. The calendering unit according to claim 6, wherein the calendering module comprises a control unit that is configured to set one or more process parameters of the calendering unit depending on the sensor data.

8. The calendering unit according to claim 5, wherein
the calendering module comprises a first rotating element, and a second rotating element that form a gap through which the printed recording medium is guided so that the first side of the printed recording medium contacts the first rotating element;
the first rotating element has a metal surface; and
the second rotating element has a polymer-based and/or rubber-based surface.

9. The calendering unit according to claim 8, wherein the first rotating element comprises a first roller and the second rotating element comprises a second roller.

10. The calendering unit according to claim 5, wherein the calendering unit has a plurality of successive calendering modules that are respectively configured to calender the printed recording medium in order to incrementally reduce the difference value between the first value of the reflective property in the first partial region and the second value of the reflective property in the second partial region.

11. A printing device comprising:
a print group that is configured to print a print image onto a recording medium so that the printed recording medium has a first side with an unprinted first partial region and with a printed second partial region; and
a calendering unit comprising at least one calendering module configured calender the printed recording medium in order to reduce a difference value between a first value of the reflective property in the first partial region and the second value of the reflective property in the second partial region.

12. The printing device according to claim 11, wherein the calendering module comprises a sensor module that is configured to acquire sensor data with regard to the first value, the second value, and/or the difference value of the reflective property, before and/or after the printed recording medium has traveled through the calendering module.

13. The printing device according to claim 12, wherein the calendering module comprises a control unit that is configured to set one or more process parameters of the calendering unit depending on the sensor data.

14. The printing device according to claim 11, wherein
the calendering module comprises a first rotating element and a second rotating element that form a gap through which the printed recording medium is guided so that the first side of the printed recording medium contacts the first rotating element;
the first rotating element has a metal surface; and
the second rotating element has a polymer-based and/or rubber-based surface.

15. The printing device according to claim 14, wherein the first rotating element comprises a first roller and the second rotating element comprises a second roller.
